(19) United States
(12) Patent Application Publication
(10) Pub. No.: US 2004/0059693 A1
(43) Pub. Date: Mar. 25, 2004

(54) Parking space payment method

(76) Inventors: Axel Hausen, Dreieich (DE); Thierry Mougin, Saint Vit (FR)

Correspondence Address: ROSENTHAL & OSHA L.L.P., 1221 MCKINNEY AVENUE, SUITE 2800, HOUSTON, TX, 77010, US

(21) Appl. No.: 10/470,122

(22) PCT Filed: Jan. 29, 2002
(86) PCT No.: PCT/IB02/00292

(30) Foreign Application Priority Data
Jan. 30, 2001 (FR) 01/01344

(51) Int. Cl. G07B 15/02

(52) U.S. Cl. 705/418

(57) ABSTRACT

The invention relates to a method for the payment of a service, such as parking rights for an automotive vehicle, issued by a terminal such as a Pay & Display machine. The method includes the stages of: a user who has first registered with a server calls the said server using appropriate telecommunication means; the said server identifies the said telecommunication means, the user and the terminal through the call signal and sends a message authorising access to the said terminal; when said message is received, the said terminal authorises the user to use its services on set conditions

This invention covers a method using a mobile telephone for paying for a product or service dispensed by a device. This invention particularly covers payment for a parking space or parking fees for an automotive vehicle with the help of a payment terminal such as a Pay & Display machine, parking meter or pay on foot device using a mobile telephone.

In particular, international application WO 96/11453 covers a pay parking management system built around a mobile telephone network, where the user makes a call with his or mobile telephone to a parking server in order to indicate the selected parking area and supply a vehicle identifier such as the registration number and possibly a personal identifier code. The parking server records the call data and the time when the parking period starts. When the user leaves the parking space, he or she calls the server once again to inform it of the same. On the basis of the parked time and the tariff applicable in the parking area, the server calculates the fees due from the user and makes out a bill, either directly to the user or through the mobile telephone operator or through other parties such as banks.

In this known system, enforcement is performed by enforcement agents who have handheld devices that enable them to call the parking server by telephone in order to find out if the parked cars, which are particularly identified by means of their registration number, are regularly registered with the server.

Even though the pay parking management system described above offers a certain number of benefits, it does have a few drawbacks given the current state of techniques.

The user of the system is required to make—and therefore pay for—two telephone calls to the server, which can be very expensive in view of the average parking fee. The parking operator is required to kit out its enforcement agents with special equipment that has a considerable operating cost, as it implies calling the parking server. Also, enforcement is a lengthy process as for each vehicle, the personnel must enter the identifier, registration number or identification number provided on a label placed visibly on the vehicle.

Besides, the known pay parking management system does not enable the user to see his or her current parking rights in the form of a receipt (ticket etc.). Such a system is further not compatible with existing payment terminals such as Pay & Display machines that issue parking tickets to be placed behind the windscreen of the vehicle or provide lists of space numbers or parked vehicle registration numbers entered in the Pay & Display machines by users. The result is a either a loss of information or the need to use more complex software if financial statements or statistics are to be prepared for a complete system combining the facility to issue parking tickets from parking terminals or a server.

Lastly, it can be observed that if users forget to report their departure to the server, the parking time continues to be debited, inevitably leading to disputes about bills.

Those are the technical problems this invention sets out to solve, by proposing a payment method that uses both a mobile phone and existing payment terminals (Pay & Display machines, parking machines, pay on foot devices etc.), which are connected to a server. The process makes it possible to use the resources of mobile telephony for pay parking without the drawbacks mentioned above.

The method according to the invention applies to payment for a product or service such as the right to park an automotive vehicle, issued by an automatic device or terminal such as a Pay & Display machine.

According to the invention, the method is characterised in that it includes the following successive stages:

The user first registers with the server by calling it through appropriate telecommunication means;

The server identifies the user and the terminal through the call and sends an access authorisation message corresponding to the terminal;

When the message is received, the terminal authorises the user to use its services on set conditions specified in the said message.

According to another characteristic of the method covered by this invention, the authorisation message includes tariff parameters that are specific to the user and are determined when the user registers with the server. The terminal determines the cost of the services issued to the user on the basis of the tariff parameters.

According to another characteristic of the method covered by this invention, the authorisation message includes payment parameters, which are specific to the user and are determined when the user registers with the server. The terminal issues the services to the user subject to those payment parameters.

According to another characteristic of the method covered by this invention, the user pays for all of part of the services directly to the terminal with appropriate payment methods.

According to another characteristic of the method covered by this invention, all or part of the services used by the user are charged to the user by the server, which receives a transaction report from the terminal specifying the services used by the user.

According to another characteristic of the method covered by this invention, the server identifies the terminal by the telephone number used by the user to call the server.

According to another characteristic of the method covered by this invention, the user calls the server by dialling a special number displayed on the terminal.

According to another characteristic of the method covered by this invention, the server identifies the user by the telephone number used to call the server.

According to another characteristic of the method covered by this invention, the server includes means to identify the calling telephone number without answering the call.

According to another characteristic of the method covered by this invention, the user stops the call to the server as soon as a signal indicating connection to the server is established, such as a ring signal.

According to another characteristic of the method covered by this invention, the user is required to divulge his or her identity by entering a personal password to access the services provided by the terminal.

According to another characteristic of the method covered by this invention, the user accesses the server through a mobile telephone.

According to another characteristic of the method covered by this invention, the value of the services consumed by the user is debited from an account with the server or a bank operator or a telecommunications network operator.

According to another characteristic of the method covered by this invention, the value of the services consumed by the user is debited from a prepaid account.

According to another characteristic of the method covered by this invention, that prepaid account is chargeable with a prepaid scratch card.

According to another characteristic of the method covered by this invention, the value of the services consumed by the user is debited from an e-purse or bank card inserted in the telephone by the user.

According to a specific mode of embodiment of the method covered by this invention, the method makes it possible to pay the parking fees for an automotive vehicle by using at least one Pay & Display machine connected to a parking server. In that case, the process includes the following stages:

A user with a mobile telephone and a subscription to a mobile telephone network calls the parking server at a number provided on the Pay & Display machine;

The server automatically identifies the calling telephone number and the called number and thereby identifies the relevant Pay & Display machine and the user;

The server transmits an authorisation message (after checking the user's account) to the Pay & Display machine so that the user can enter the parking time;

The Pay & Display machine issues a parking ticket;

The Pay & Display machine reports the data about the parking time requested by the user to the server;

The server charges the user for the parking time.

Parking time data are reported by the terminal to the parking server either just before the end of the transaction or when financial transactions are periodically collected from the terminal, at the latest.

As a result, according to the method covered by the invention, the tariff of a service, for instance parking fees, is determined on the basis of the requested parking time and the location of the terminal, and also on the basis of the user's personal parameters, which are defined when the user registers with the operator of the parking server (or during the subscription process), and which may include subscription to parking packages etc.

These personal parameters are chiefly of two types, tariff parameters and payment parameters. Tariff parameters play a part in the calculation of the parking fees, taking account of the address of the user to apply a residential tariff etc. Payment parameters relate to the financial capacities allocated to the user in terms of value and time. As with bank cards or credit, they may include a limit on the expenditure by the user over a given period of time or for a given transaction etc.

Besides, the personal parameters of the user may enable access to other services provided by the terminal, and the terminal may be an interactive terminal offering access to a number of services—city guidance, hotel bookings etc.

For instance, according to the method covered by the invention, it is possible to authorise combined payment, where in the same transaction, the user pays via a remote parking server and his or her mobile phone and other means of payment (coins, notes, bank cards etc.).

For instance, according to the method covered by the invention, the mobile phone may simply be used to identify the user and provide the specific rights for the transaction under way.

According to the method covered by the invention, all terminals may involved—Pay & Display machines, pay on foot devices, parking meters or any other machines that vend goods or services.

The description below refers to the enclosed drawing and is a non-limitative example that shows the component elements of the invention and how it can be put into operation.

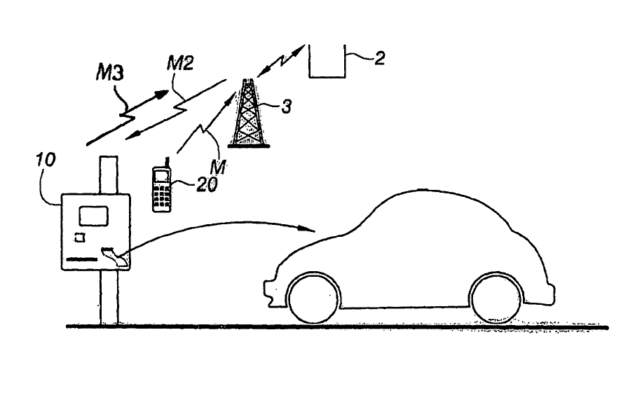

FIG. 1 is a diagram of a mode of implementation of the method according to the invention.

The diagram of FIG. 1 illustrates a method for paying on-street parking fees or fees for parking an automotive vehicle in an open car park.

Terminals 10, also called Pay & Display machines, are installed along the street. When a motorist wishes to park his or her car, he or she goes to the nearest terminal 10 and pays a certain amount of money to cover the desired parking time, with coins or with an appropriate payment card or with banknotes, cheques or value tokens.

When the parking fees are paid, the motorist is authorised to park the vehicle for a set time. The terminal issues the parking right, e.g. by issuing a ticket with printed information, particularly the parking time limit. The motorist is required to place the ticket as proof of payment of the parking fees behind the windscreen of his or her car.

The parking enforcement agent simply compares the time stated on the ticket with the current time to find out if the vehicle is parked regularly. Otherwise, the agent can apply a penalty against the motorist.

For the user, such parking systems offer the benefit of being clear, because the parking limit time is displayed very distinctly on the ticket received. For the user municipalities, it also involves relatively low investment costs and great ease of checking. The ticket also acts as a payment receipt for users.

According to the invention, Pay & Display terminals 10 are also suitable for calculating parking fees and accepting payment of the same, on the basis of a phone call made by the user with his or her mobile telephone 20 communicating through a wireless telecommunication network 3 such as GSM, CDMA, TDMA, AMPS, D-AMPS, PCS, etc.

To that end, each Pay & Display machine 10 is connected to server 2 also called an MPMS (Mobile Payment Management System) which manages the payment by telephone from Pay & Display machines 10. The link between Pay & Display machines 10 and MPMS 2 is made through a communication network that may a wired analogue PSTN (Public Switching Telephone Network) or an ISDN (Integrated Services Digital Network). The network between MPMS 2 and Pay & Display machines 10 may also be made up of the aforementioned mobile wireless telephone network 3 or a second mobile telephone network distinct from the first one, regardless of its nature, GSM, CDMA, TDMA, AMPS, D-AMPS, PCS or the Internet or generally any communication network capable of transmitting data (X.25, Ethernet, etc.) and any combination of networks.

Pay & Display machines 10 and MPMS 2 are therefore fitted with appropriate supervision means and the means to receive and transmit data. The means, which are themselves known, will not be described in further detail. These supervision and reception/transmission means are responsible for organising the exchange of information between Pay & Display machines 10 and MPMS 2.

The user, who wishes to use the tariff and payment system of Pay & Display machines via his or her mobile telephone 20, must first register with the operator in charge of the service. The operator may be either the mobile telephone operator of the user or an independent operator or even the Pay & Display machine manager.

During the registration process, the user provides certain particulars that make it possible to identify the user and particularly the user's mobile telephone 20 and also the number of the SIM (Subscriber Identity Module) card in the telephone. Other information may also be submitted such as the registration number of the vehicle or the number of a reserved parking space.

The user additionally supplies personal information such as for instance his or her home address (for residential parking), occupation etc. and selects packages that determine the tariff parameters proposed to the user, such as access to special parking tariffs (concessionary tariff, flat tariff, free parking, deposit and recovery tariff etc.).

The user also determines the financial conditions for accessing the service. These payment parameters relate to the financial capacities allocated to the user in value or time. As with bank cards or credit, the expenditure of the user may be subject to an upper limit for a given period of time or for a given transaction etc. The user also determines the desired payment mode as detailed below.

Likewise, the user may be required to select from different optional services proposed by the operator for a charge, such as automatic calls to the user to remind him or her that the parking time is up or the territorial coverage of the service—limited to a city, a county, a country etc.

Also, the user may be required to select from different services relating to the payment of the services charged—account reloading, authorised credit, prepayment etc.

Further, the user may subscribe to other services proposed by the Pay & Display machines, which may be interactive terminals offering access to some services—city guidance, hotel booking etc.

Of course, all the standard functions of Pay & Display machines 10 remain accessible to the user via server MPMS 2, particularly real-time parking. This function is used to modify the duration for the parking ticket after the initial transaction is validated (stopping or extension). Real time parking is a method where only the actual parking time is debited from the user's account and the user only pays for the time “consumed”.

In this operating mode, the parking ticket is saved in the Pay & Display machine with an identifier, which is also printed on the ticket or displayed by an enforcement agent.

When the user returns, if the parking time paid has not elapsed, the user can get back the value of the remaining time that has not been consumed.

For example, the Pay & Display ticket has a detachable part with a secret code. When the user gets back to his or her car, he or she enters the code into the Pay & Display machine. The parking terminal then looks for the associated ticket in its database and modifies the transaction (with optionally a printout of a new ticket that acts as the receipt).

The user's mobile phone number can act as the secret code, which offers the advantage of simplifying the user interface (no need to print a code).

As a variant, the user calls the MPMS server once again and the MPMS server sends a second authorisation. The new authorisation arrives before the current parking ticket is used up and the Pay & Display machine infers that this is a request for real time parking and calculates the amount to be debited accordingly.

Likewise, if the time is exceeded, the user can extend the parking rights, if the payment parameters (limit time, maximum value etc.) are still valid.

If the parking rights are modified, i.e. stopped or extended, the current ticket may be cancelled or re-issued with the new rights (time, value) respectively in the database of the Pay & Display machine.

For enforcement actions, an agent can then look up the list of valid/invalid parking tickets (in real time), either by printing out a test ticket or by transferring data to computer equipment from where it can be viewed and/or processed for enforcement purposes.

According to the parking method covered by this invention, a user registered with the remote payment operator of the Pay & Display machines who wishes to use the services offered—pricing, payment (all or part), access to special services etc. by means of his or her mobile telephone 20, goes before Pay & Display machine 10 and just dials the telephone number stated on Pay & Display machine 10 with his or her mobile phone, waits for a ring and hangs up. That operation only lasts a few seconds.

As a variant, a text message M of the SMS (Short Message System) type may be sent from telephone 20, where the said message is limited to the aforementioned number.

The call or message sent by the user is received by MPMS 2, which manages all the call numbers of the Pay & Display machines supervised by it.

Regardless of the communication technology used on network 3—analogue with a modem or digital using the ISDN protocol, MPMS 2 receives the number of the calling telephone along with the ring signal from the switchboard. Using appropriate means, MPMS 2 immediately identifies the Pay & Display machine 10 involved, as each Pay & Display machine 10 has a distinct telephone number, and the number of the calling mobile phone, without there being any need for communication between MPMS 2 and mobile telephone 20. Once the identification is complete, the server sets off the procedure for activating the Pay & Display machine.

Server 2 first checks a certain number of data relating to the calling telephone, such as its possible presence on a blacklist of stolen handsets, and above all if the number is registered. The server also checks if the call is genuine.

After these verifications, MPMS 2 establishes communication with Pay & Display machine 10, for example in the form of an appropriate message M2 supplying the parameters relating to pricing, payment or access to the Pay & Display machine 10 specific to the user.

Pay & Display machine 10 stands by for the user to enter the requested parking time, e.g. by displaying a welcome message, which may be personalised, on the screen of the Pay & Display machine along with the operating procedure. As a variant, the user initiates the transaction by pressing key 11 of the Pay & Display machine, which is that of the Telephone Payment function.

In addition to the entry of the requested parking time by the user, the user may also enter a secret code that has been supplied upon registration with the remote payment service, in order to ensure that the user who calls server MPMS 2 and the user who collects parking rights from Pay & Display machine 10 are one and the same person. The secret code is verified directly by the Pay & Display machine 10 that receives the code inside message M2, or by MPMS 2 through appropriate communication.

Pay & Display machine 10 displays the hourly parking tariff determined on the basis of the tariff parameters that have been sent to it by MPMS 2. With the keypad of the Pay & Display machine, the user enters the required parking time and then decides the mode of payment, either directly with appropriate payment methods such as notes, bank cards etc. or via server MPMS 2, or by combining the two modes of payment. When any part of the parking rights are paid through server MPMS 2, the Pay & Display machine validates the payment on the basis of the user's payment parameters.

Once the parking rights have been paid, Pay & Display machine 10 prints out a conventional ticket 11, which acts as a means to check if parking is authorised. Ticket 11, which indicates at least the time when the parking period ends, is then placed by the user inside the vehicle in a visible location so that it can be checked by the enforcement agents.

As soon as the transaction is completed, Pay & Display machine 10 sets up communication with MPMS 2, for example in the form of an appropriate message M3 stating the time and/or the value of the parking requested by the user. Otherwise, the information is reported in grouped form (several transactions) at a frequency defined by the operator of the parking server.

According to the method described above, server MPMS 2 supplies all the data that enable the Pay & Display machine to serve the user offline, i.e. by using only the hard and software resources contained in Pay & Display machine 10. The invention is not limited to this procedure and may also be implemented online, i.e. through server MPMS 2, where communication between Pay & Display machine 10 and server MPMS 2 is maintained throughout the transaction. In that case, the Pay & Display machine only acts as an interface between the user and server MPMS 2, and MPMS 2 calculates the price of parking on the basis of the information about the parking place and time, the user's particulars or any subscription packages. All the information above helps determine the tariff to be applied (e.g. residential tariff).

The amount is directly debited from the user's account with the operator of mobile telephone network 3 or MPMS 2.

Other modes of payment may be envisaged such as debiting a prepaid account with the operator of parking server MPMS 2. To reload the account, the user buys a prepaid scratch card, e.g. a value of FF. 100 in parking rights, calls the server with the mobile phone and enters the number provided on the scratch card. The prepaid account is then credited with FF. 100. When the user wants to park his or her vehicle, he or she calls the parking server, his or her account is recognised through the SIM card and the balance is displayed on the screen to inform the user of the value of the parking rights available.

A mobile phone 20 with two slots that allow for the presence of a SIM card and a card reader designed for an e-purse card or a bank card may also be used to perform transactions via mobile telephone 20. In that case, to pay the parking fee, the user inserts his or her e-purse or bank card into the mobile telephone reader and makes the payment securely via MPMS 2, which records the transaction, debits the card and handles clearance procedures with the bank.

Of course, this invention is not limited to Pay & Display machines alone, but is also applicable to pay on foot devices, parking meters or all other equipment and systems that control parking (opening of barriers or gates in an access control system) and also more generally all automatic devices that vend goods or services.

1. Method for the payment of a service, such as parking rights for an automotive vehicle, issued by a terminal (10) such as a Pay & Display machine, characterised in that it includes the following successive stages:
A user who has first registered with a server (2), calls the said server (2) using appropriate telecommunication means;
The said server (2) identifies the said telecommunication means, the user and the terminal (10) through the call signal and sends a message authorising access to the said terminal (10);
When the said message is received, the said terminal (10) authorises the user to use its services on set conditions.

2. Method for the payment of a service according to claim 1, characterised in that the said authorisation message includes tariff parameters, which tariff parameters are specific to the said user and are determined when the user registers with the said server (2) and in that the said terminal (10) determines the cost of the services issued to the user by taking account of the said tariff parameters.

3. Method for the payment of a parking space according to claim 1, characterised in that the said authorisation message contains payment parameters, which payment parameters are specific to the said user and are determined when the user registers with the said server (2) and in that the said terminal (10) issues the services to the said user subject to the said payment parameters.

4. Method for the payment of a service according to any claim from 1 to 3, characterised in that the said user pays all or part of the services directly to the terminal using appropriate payment means.

5. Method for the payment of a service according to any claim from 1 to 4, characterised in that all or part of the services used by the user are charged to the said user by the said server (2), which server (2) receives from the said terminal (10) a transaction report specifying the services used by the said user.

6. Method for the payment of a service according to any claim from 1 to 5, characterised in that the said server (2) identifies the said terminal (10) with the telephone number used by the said user to call the said server (2).

7. Method for the payment of a service according to claim 6, characterised in that the said user calls the said server (2) by dialling a particular call number posted on the said terminal (10).

8. Method for the payment of a service according to any claim from 1 to 7, characterised in that the said server (2) identifies the user by the telephone number of the telephone (20) used by the said user to call the said server (2).

9. Method for the payment of a service according to claim 8, characterised in that the said server (2) includes means to identify the telephone number of the calling telephone without answering the call.

10. Method for the payment of a service according to claim 9 characterised in that the user stops the call to the server (2) as soon as a signal is emitted to indicate connection with the said server such as a ring signal.

11. Method for the payment of a service according to any claim from 1 to 10, characterised in that in order to access the services of the said terminal (10), the user must divulge his or her identity by entering a personal password.

12. Method for the payment of a service according to any claim from 1 to 11, characterised in that the said user accesses the said server (2) through a mobile telephone (20).

13. Method for the payment of a service according to any claim from 1 to 12, characterised in that the value of the service is debited from an account with the server (2) or a bank operator or a telecommunications network operator (3).

14. Method for the payment of a service according to any claim from 1 to 13, characterised in that the value of the service is debited from a prepaid account.

15. Method for the payment of a service according to claim 14, characterised in that the said prepaid account is rechargeable with a prepaid scratch card.

16. Method for the payment of a service according to claim 12, characterised in that the value of the service is debited from an e-purse card or a bank card inserted in the said telephone (20).

17. Method for the payment of a parking space for an automotive vehicle according to any of the claims above, using at least one Pay & Display machine (10) connected to a parking server (2), characterised in that it includes the following successive stages.
A user with a mobile telephone (20) subscribing to a mobile telephone network (3) calls the said parking server (2) at a telephone number stated on the said Pay & Display machine;
The said server (2) automatically identifies the calling telephone number and the called telephone number and thereby identifies the relevant Pay & Display machine (10) and the user;
The said server (2) transmits an authorisation message to the Pay & Display machine (10) so that the said user can enter a parking time;
The said Pay & Display machine issues to the said user a parking ticket (11);
The said Pay & Display machine (10) sends to the said server (2) information about the parking time requested by the user;
The said server (2) charges the parking time to the said user.
